(19) United States
(12) Patent Application Publication
(10) Pub. No.: US 2010/0248605 A1
(43) Pub. Date: Sep. 30, 2010

(54) INTEGRATED BLOWER GRID

(75) Inventors: Rajeev Sharma, Troy, MI (US); Simon Hotte, Windsor (CA)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/415,421

(22) Filed: Mar. 31, 2009

(51) Int. Cl. B60H 1/26; B60H 3/06

(52) U.S. Cl. 454/140; 454/158

(57) ABSTRACT

An apparatus for a heating, ventilating and air conditioning (HVAC) system may employ a blower case that houses a fan and a motor to drive the fan, an air intake case that houses an air filter, a grill that contacts and supports the filter, a fresh air intake and a recirculation air intake. The grill may be located directly over the fan to protect the fan and motor from debris. The air intake case may employ a fresh air inlet and a recirculation air inlet such that air entering either may have an airflow path through the HVAC system in the order of: the fresh air intake, the filter, the grill, the fan, and the blower case. An intermediate grill panel and the grill may be integrally molded together as one single piece to improve NVH, reduce overall part count and save manufacturing time.

### FIELD

The present disclosure relates to an integrated blower grid for a vehicle heating, ventilating and air conditioning system.

### BACKGROUND

This section provides background information related to the present disclosure which is not necessarily prior art. Modern vehicles, such as automobiles, include climate control systems or heating, ventilating and air conditioning (HVAC) systems that function to heat, ventilate and cool a cabin or passenger compartment of a vehicle. HVAC systems often include a fresh air inlet, a recirculated air inlet, and a fan driven by an electric motor for drawing air from one or both of the inlets. The air may be subsequently heated or cooled and discharged into the passenger compartment through one or more of a plurality of vents. Operation of the HVAC system may generate noise, which may adversely affect vehicle occupants' comfort and enjoyment of the vehicle. The present disclosure provides an HVAC system that may reduce noise audible in the passenger compartment while improving or maintaining airflow characteristics and/or other operating conditions throughout the system. Additionally, because vehicle HVAC systems draw air from an exterior of the vehicle and discharge the air to an interior of the vehicle, HVAC systems may draw in debris such as leaves, which may lodge in the HVAC fan.

FIG. 11 depicts a prior art design in which a blower case 100 houses a fan 102 that draws either fresh air 104 into the blower case 102 via a fresh air inlet 106 or recirculation air 108 via a recirculation air inlet 110. Only the recirculation inlet 110 has a screen 112 over it to prevent objects from being drawn into the fan 102.

### SUMMARY

This section provides a general summary of the disclosure, and is not a comprehensive disclosure of its full scope or all of its features. An apparatus for a heating, ventilating and air conditioning (HVAC) system may employ a blower case that contains or houses a blower fan that is driven by an electric motor. The system may further employ an air intake case that defines a fresh air inlet or intake and a recirculation air inlet or intake. An air filter may be located downstream of the fresh air inlet or intake and the recirculation air inlet. Below the filter, an intermediate grid or grill panel may define a grill, the grill further defining a flat surface that contacts the filter such that the grill physically supports the weight of the filter. The flat surface of the grill may define a plurality of polygonal apertures molded through the flat surface of the grill and that are disposed in the airflow path. The grill may be located directly over the fan to protect the fan from debris. The intermediate grill panel and the grill may be a single integrally molded piece to prevent vibration and noise from emanating from the grill location. A filter change door may be located next to the filter to provide quick and easy access to the filter. A quantity of polygonal apertures, such as six-sided honeycomb structures, may be molded through or into the flat surface of the grill and disposed in the airflow path. Each of the plurality of polygonal apertures may be a six-sided polygon with widths or distances across opposing flat faces of between 4 millimeters and 5 millimeters.

Further areas of applicability will become apparent from the description provided herein. The description and specific examples in this summary are intended for purposes of illustration only and are not intended to limit the scope of the present disclosure.

### DRAWINGS

The drawings described herein, which may be to scale, are for illustrative purposes only of selected embodiments and not all possible implementations, and are not intended to limit the scope of the present disclosure.

FIG. 1 is a side view of a vehicle depicting an example location of an HVAC case and blower assembly within the vehicle;

FIG. 2 is a perspective view of a vehicle interior depicting an example location of an HVAC case and blower assembly;

FIG. 3 is a top perspective view of a blower assembly depicting fresh and recirculation air inlets;

FIG. 4A is an exploded view of the blower assembly of FIG. 3;

FIG. 4B is a further exploded view of the blower assembly of FIG. 3;

FIG. 5 is a bottom perspective view of the blower assembly of FIG. 3;

FIG. 6 is an enlarged partial perspective view of a blower assembly;

FIG. 7 is a multi-view of a fan grill of an embodiment of the present disclosure;

FIG. 8 is a multi-view of a fan grill of an embodiment of the present disclosure;

FIG. 9 is a multi-view of a fan grill of an embodiment of the present disclosure;

FIG. 10 is a multi-view of a fan grill of an embodiment of the present disclosure;

FIG. 11 is section view of the blower assembly according to an embodiment of the present disclosure; and

FIG. 12 is a prior art structure.

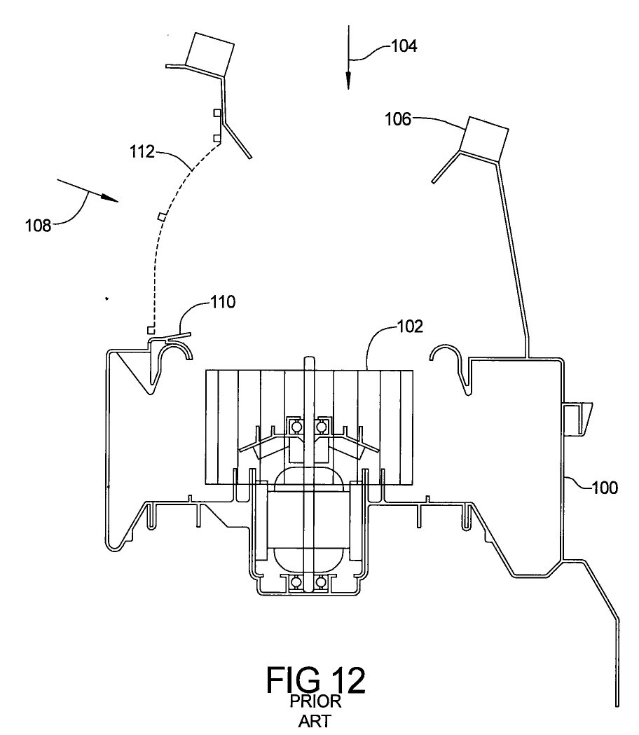

Corresponding reference numerals indicate corresponding parts throughout the several views of the drawings.

### DESCRIPTION

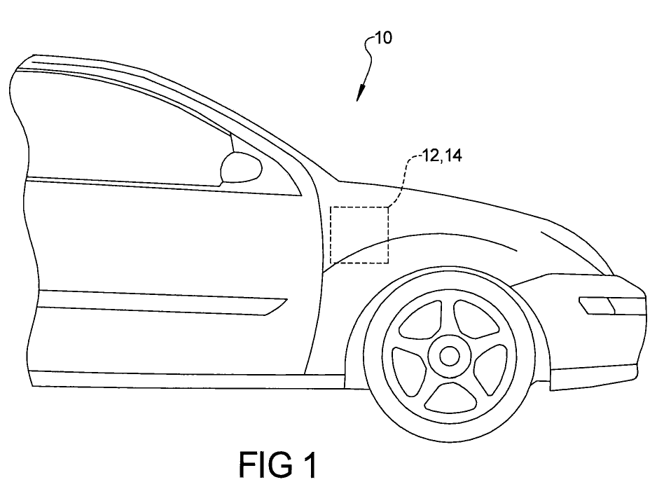

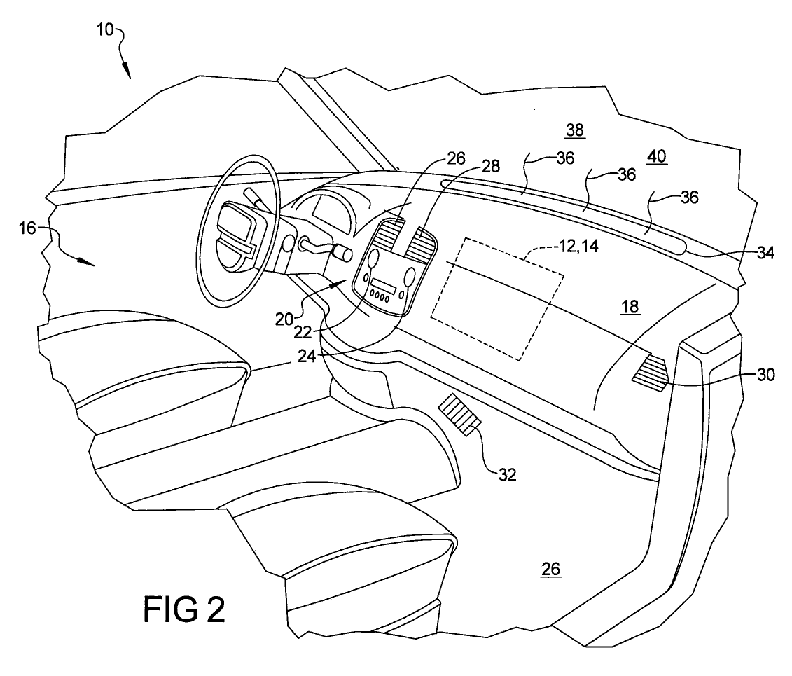

Example embodiments will now be described more fully with reference to the accompanying drawings. With reference to FIGS. 1-11, teachings of the present disclosure will be presented. Turning first to FIG. 1, a vehicle 10 is depicted with a location of a heating, ventilating and air-conditioning (“HVAC”) assembly 12, which includes a blower assembly 14 depicted in phantom. Turning next to FIG. 2, vehicle 10 has vehicle interior 16 with a dash 18 that exhibits an HVAC control panel 20. HVAC control panel 20 may posses first knob 22 and second knob 24 to control functions of an HVAC assembly 12. As depicted in FIG. 2, HVAC assembly 12 may be located immediately behind dash 18, such as behind HVAC control panel 20; however, HVAC assembly 12 may be positioned in various positions in vehicle 10, such as in the rear of a vehicle, and the teachings of the present disclosure may be applicable to an HVAC assembly 12 regardless of location.

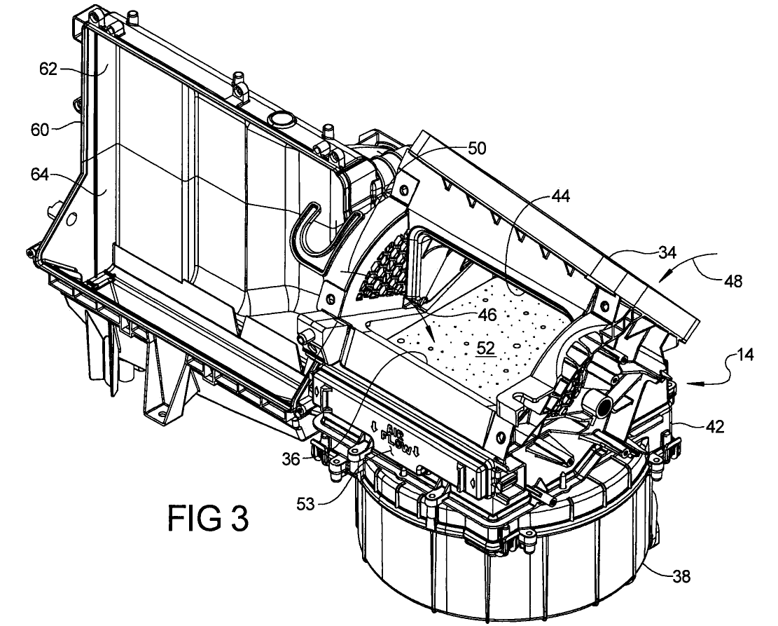

Continuing with FIG. 2, while control knob 22, as an example, may be used to control specific doors within the HVAC assembly 12 to control airflow into the vehicle interior 16, such as whether air flows out of dash vents 26, 28, 30 to direct air at the face and torso of passengers, from a floor vent 32 to direct air at feet of a passenger, or from a defroster vent 34 to direct airflow 36 at an interior surface 38 of a windshield 40, control knob 24 may be used to switch or alter the air supply into the vehicle interior 16 via vents 26, 28, 30, 32 from an exterior air supply to a recirculation air supply. More specifically, and with reference now including FIGS. 3-5, the air supply into the vehicle interior 16 may be routed through either or both of a fresh air intake 34 or a recirculation air intake 36 before reaching outlet vents 26, 28, 30, 32, 34 within the vehicle interior 16. As depicted in FIG. 3, the blower assembly 14 may employ a blower case 38, within which a fan 40 may reside. The blower case 38 may be connected to an air intake case 42 that defines the air inlets that are the fresh air intake 34 and recirculation air intake 36.

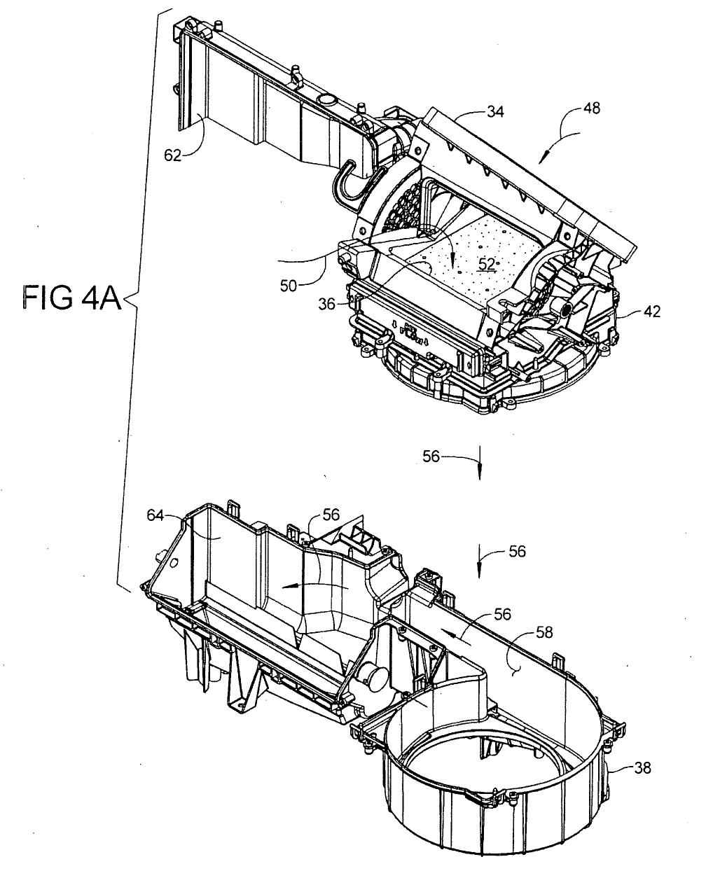

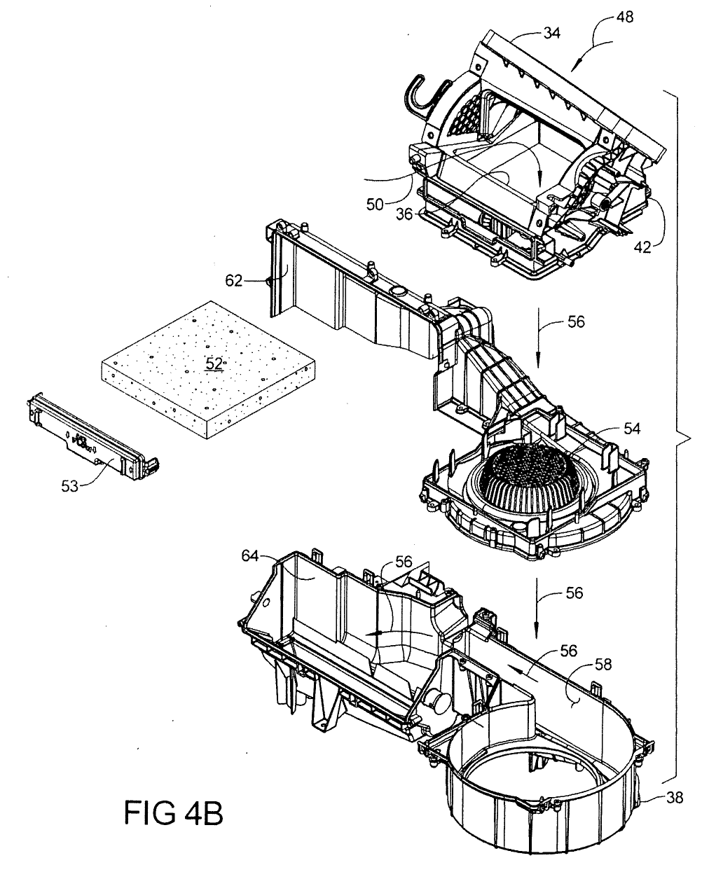

With continued reference to FIG. 3, the air intake case 42 may possess the capability to switch between modes of air intake into the blower assembly 14. More specifically, an air mode door 44 that pivots about a pivot point 46 may move such that one of either the fresh air intake 34 or the recirculation air intake 36 is covered during operation of the fan 40 to permit either fresh air or recirculation air to be drawn by the fan 40 into the blower case 38. Regardless of whether fresh air 48 or recirculation air 50, known as drawn air, enters the air intake case 42 through the drawing force of the fan 40, the drawn air must pass through an air filter 52 to reach the blower case 38. The use of air filter 52 in the location depicted in FIGS. 3 and 4 permits both, fresh air 48 or recirculation air 50, to be filtered before such drawn air is blown into the vehicle interior 16. A grill 54, also known as a grid 54, is located under the filter 52 to physically support the filter 52. Thus, the filter 52 prevents any debris such as dust, leaves, chewing gum wrappers, tissues, etc. from passing beyond the filter 52. Similarly, because the filter 52 may be a removable filter 52, the grill 54 also serves the function of preventing any debris such as dust, leaves, chewing gum wrappers, tissues, etc. from passing beyond the grill 54 should the filter 52 not be in its proper place above the grill 54.

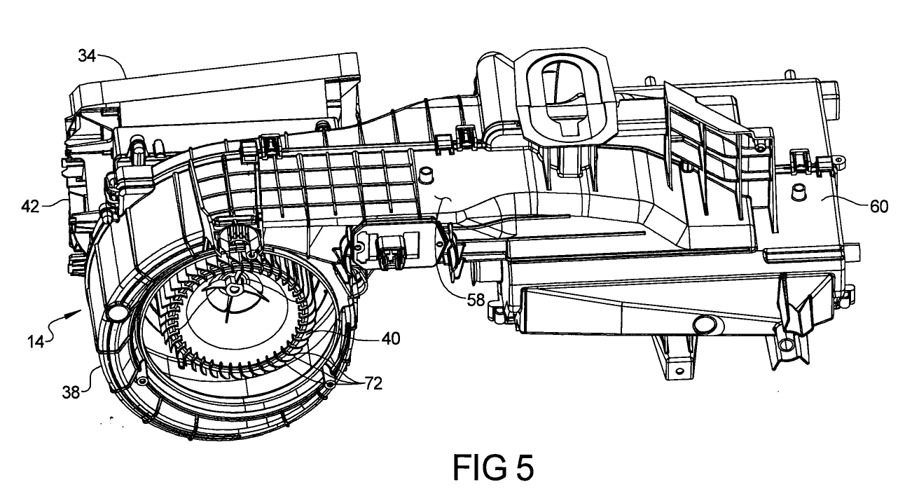

Continuing, with reference to FIGS. 4A and 4B, upon drawn air 56 passing through grill 54, the drawn air 56 passes into forced air duct 58 and into evaporator case 60, which is comprised of an upper evaporator case 62 and a lower evaporator case 64. The upper evaporator case 62 is part of the air intake case 42 while the lower evaporator case 64 is part of the blower case 38. The drawn air 56 then passes through an evaporator (not shown) located within the upper and lower evaporator cases 62, 64 and enters the vehicle interior 16 via vents 26, 28, 30, 32, 34 as selected by a user. FIG. 5 is a bottom perspective view of the blower case 38 with a bottom cover removed to expose the flower fan 40. Drawn air from the fan 40 travels through the air duct 58 and into the evaporator case 60.

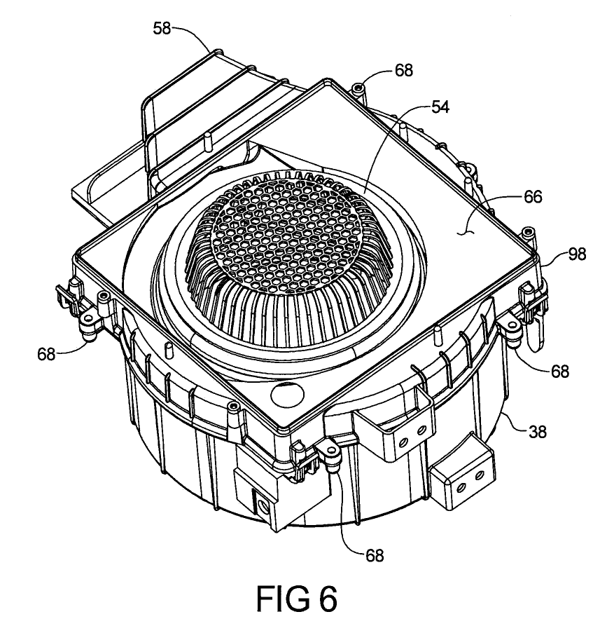

Turning now to FIG. 6, another aspect of the present teachings will be presented. More specifically, FIG. 6 depicts a blower grill 54 positioned within a planar portion 66 of the air intake case 42, which may be attached to the blower case 38 at attachment locations 72, which may accommodate a fastener (not shown), such as a threaded screw or bolt and a corresponding nut. The grill 54 may be an injected molded part that is separately fitted into the planar surface. In another scenario, the grill 54 may be molded as an integral molded part of the air intake case 42. By integrally molding the grill 54 as part of the air intake case 42, the step of separately installing the grill 54 into the air intake case 42 during assembly of the HVAC assembly 12 may be eliminated, which will save time and money associated with installation. Additionally, by integrally molding the grill 54 as part of the air intake case 42, a location of noise, vibration and harshness (“NVH”) will be eliminated. That is, when the grill 54 is manufactured as a separate piece and then fastened or connected to the air intake case 42, such as at or upon the planar surface 66, a source of NVH may exist, such as when drawn air 56 from the fan 40 passes through holes in the grill 54, thereby possibly imparting motion in the grill 54.

Continuing with FIG. 6, when the grill 54 is molded as an integral part of the air intake case 42, a source of NVH is eliminated. There are other advantages of the grill 54 being an integral part of the air intake case 42. For example, an integral grill 54 prevents any debris larger than the grill holes, such as honeycomb holes 68 or grill slots 74, from passing through the grill 54 and into the fan 40, which may damage or impede performance of the fan 40 or electric fan motor (not shown) that drives the fan 40. Additionally, by locating the grill 54 on or within the air intake case 42 as an integrally molded part of the air intake case 42, there is a balance, or rather, equality of noise that emanates from the grill 54 of air intake case 42. More specifically, regardless of whether a user has the drawn air 54 sourced from the fresh air intake 34 or the recirculation intake 36, the noise generated by the air passing through the structure that creates the holes 68 in the grill 54 will be the same. Thus, the noise resulting from either intake 34, 36 is equal and therefore balanced, because the same air resistance is created by the use of a single grill 54, which all air passing through the blower case must pass through.

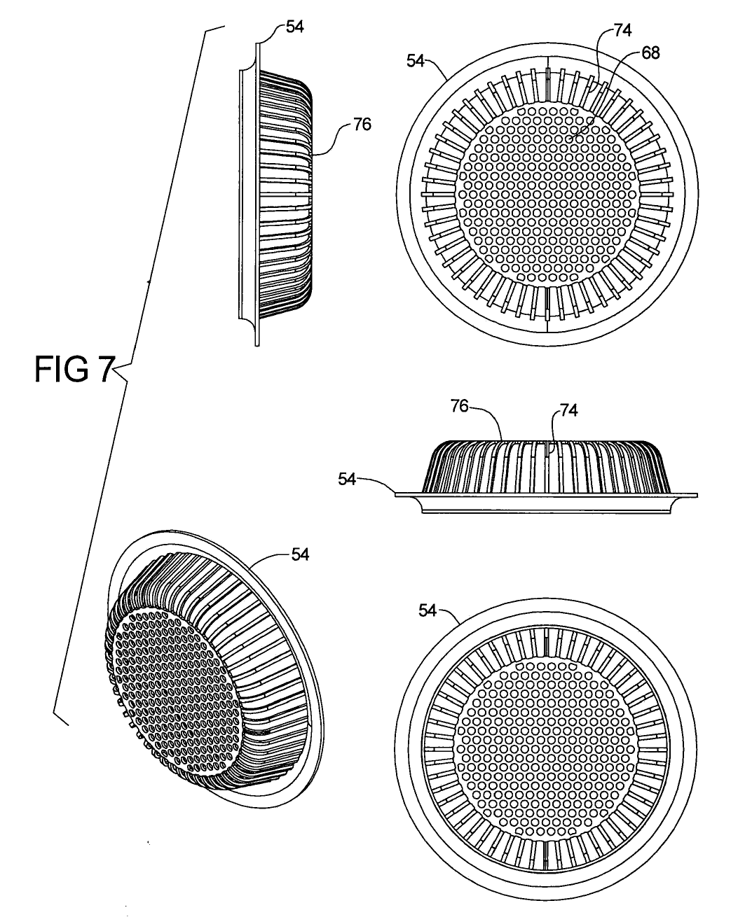

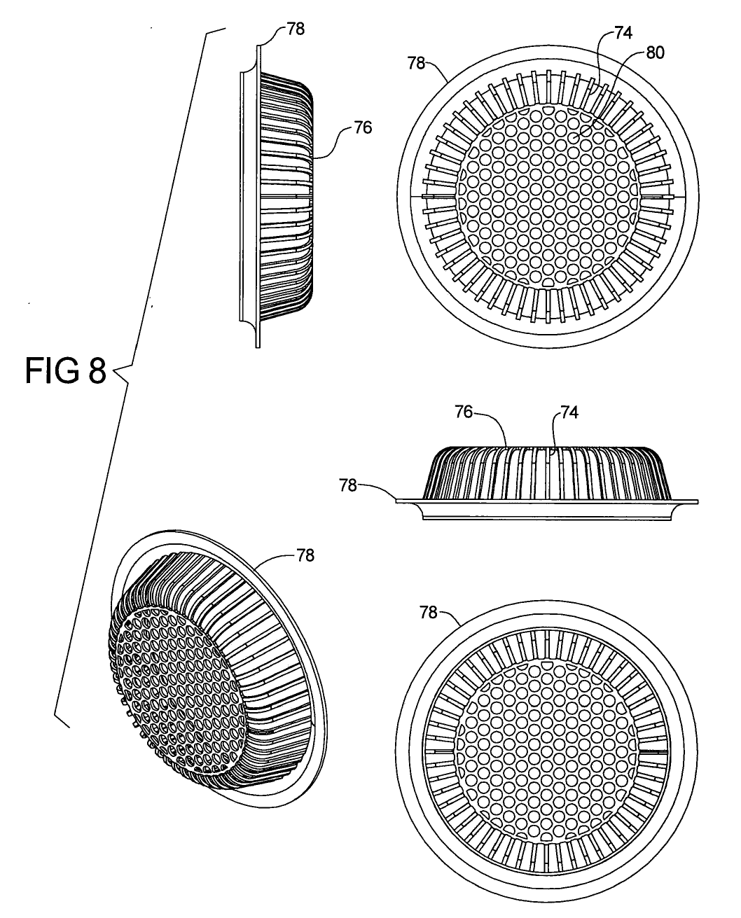

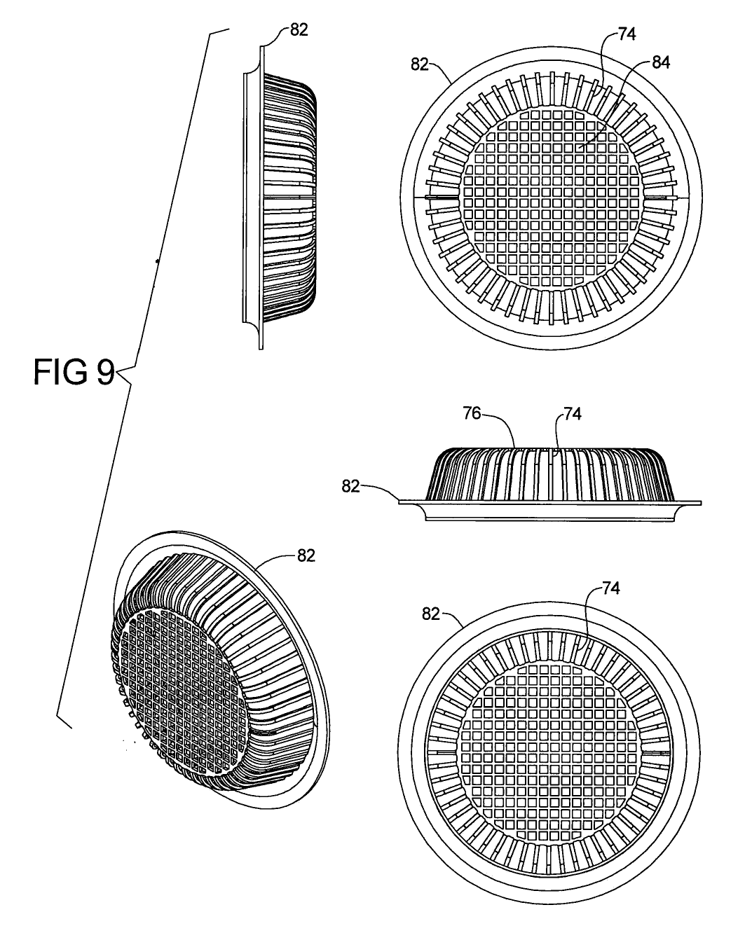

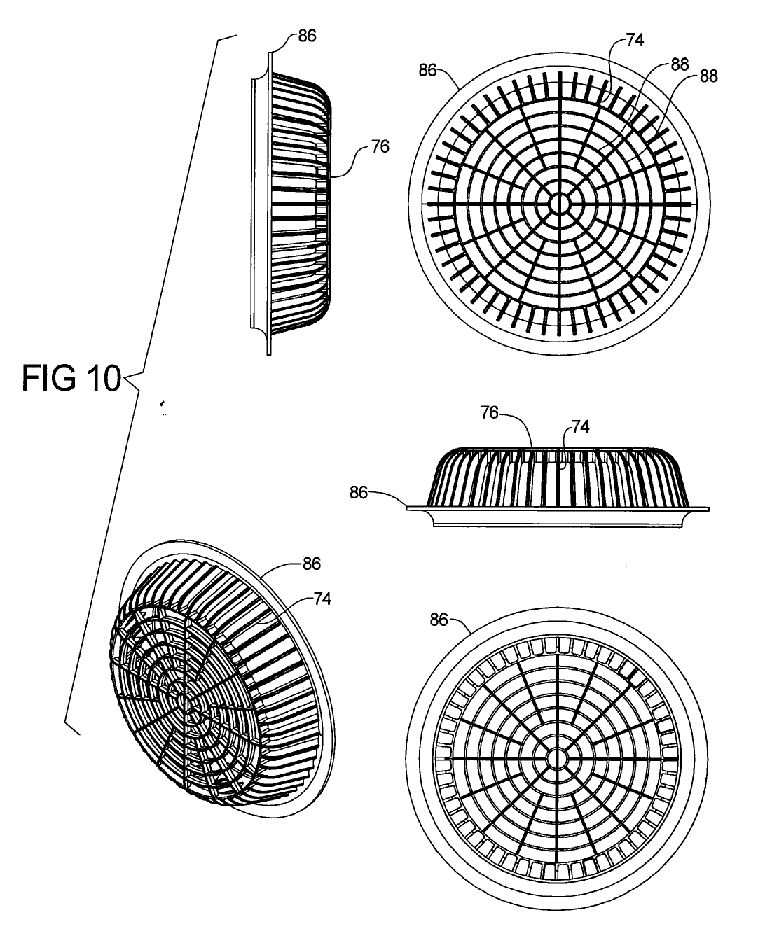

FIG. 7 is a multi-view of an embodiment of a grill 54 of the present disclosure. More specifically, the grill 54 has honeycomb holes 68, which may be six-sided holes through a flat surface 76 of the grill 54 upon which an air filter 52 may reside. About the periphery surrounding the honeycomb holes 68, grill slots 74 are slots that pass through the grill thickness to provide for the passage of air. The honeycomb holes 68 have an advantage of precipitating the least amount of audible noise due to air passing through the grill 54, compared to holes of different shapes in other grills. For instance, FIG. 8 depicts multiple views of a grill 78 with round or circular holes 80 through a level or flat surface of the grill 78. Like the embodiment of FIG. 7, a multitude of slots 74 flank the periphery of the grill 78 and also permit air to pass through the grill 78. Turning now to FIG. 9, depicted is a grill 82 having square holes 84 through the level or flat surface 76. Like the embodiment of FIG. 8, a multitude of slots 74 flank the periphery and square holes of the grill 78 and also permit air to pass through the grill 78. Additionally, FIG. 10 depicts is a grill 82 having semi-circular holes 88 or rather, arch-shaped holes 88 through the level or flat surface 76 of the grill 86. Like the embodiment of FIG. 9, a multitude of slots 74 flank the periphery and holes 88 of the grill 86 and also permit air to pass through the grill 86.

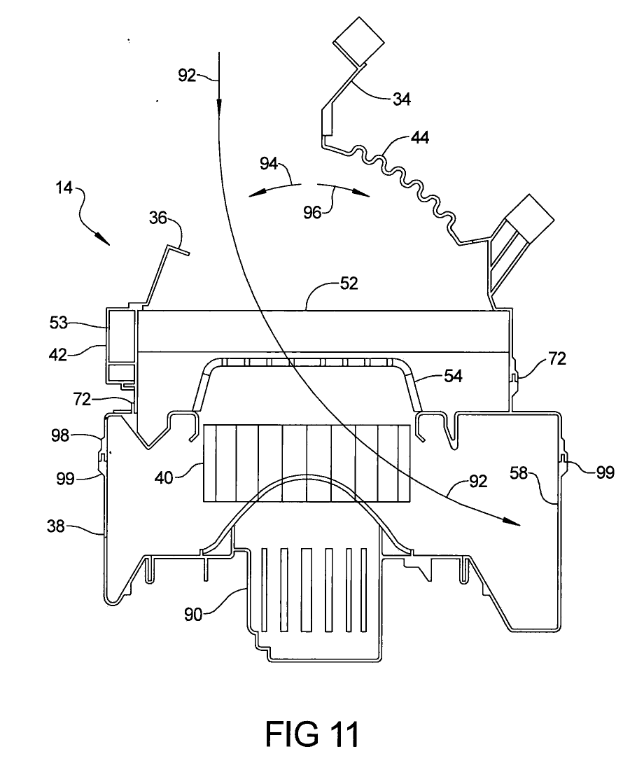

Turning now to FIG. 11, a cross-section of an embodiment according to the present teachings will be presented. FIG. 11 depicts a blower case 38 attached to an air intake case 42 using fasteners at attachment location 72. Within the blower case 38 a fan 40 driven by electric motor 90 generates an airflow 92 into the air intake case 42. The airflow 92 may enter the air intake case 42 through a recirculation intake 36 or a fresh air intake 34 depending upon the position of air mode door 44. As depicted in FIG. 11, with the air mode door 44 covering the fresh air intake 34, the airflow 92 will pass into the air intake case 42 via the recirculation intake 36 and then pass through filter 52, grill 54, blower case 38 and into air duct 58 en route to the evaporator case. Instead of the airflow 92 entering the air intake case 42 via the recirculation intake 36, the air mode door 44 may be moved in accordance with the direction of arrow 94 to cover the recirculation air intake 36. Moving the air mode door 44 in accordance with arrow 96 will again cover or block the fresh air intake 34; however, the airflow 92 will still pass through, in order, the air intake case 42 housing the filter 52, the grill 54, the blower case 38, and air duct 58 that directs the airflow 92 to the evaporator case 60.

Although the grills 54, 78, 82 and 86 depicted in FIGS. 7-10, respectively, are depicted individually, and not connected, attached or integrally molded within either the air intake case 42 or blower case 38, such grills 54, 78, 82 and 86 may be integrally molded as part of the blower case 38 or the air intake case 42. In yet another alternative, as depicted in FIG. 11, the grills 54, 78, 82 and 86 may be integrally molded as part of an intermediate grill panel 98 that attaches to the blower case 38 at attachment points 99, and that attaches to the air intake case 42 at attachment points 72. The grills 54, 78, 82 and 86 may directly contact the filter 52 to support the filter on the filter's bottom surface.

Many advantages of the teachings of the present invention are evident. For instance, by locating the grill 54 under or below the air intakes 34, 36 a single, replaceable air filter 52 may be situated directly on top of the grill 54, such as against a top surface of the grill 54. By situating or placing the air filter 52 on top of the grill 54, the air filter 52 may maintain its horizontal position, relative a level surface upon which a vehicle may reside, and be prevented from sagging due to the force of drawn air 56. Sagging in filters may be evident in filters not uniformly supported, such as filters that are non-rigid and supported only about a filter periphery. The location of the grill 54 as depicted in FIG. 6 also helps protect the fan 40, including fan blades 70 from being damaged, such as during assembly of HVAC assembly 12 or during transport. Without a grill 54 in the location depicted in FIG. 6, the fan 40 and fan blades 70 may be exposed. Moreover, by locating the air filter 52 and grill 54 as depicted in FIG. 6, an evaporator located in evaporator case 60, and also a heater core, which may also be located in the path of drawn air 56, will not become clogged with debris drawn in the airflow created by the fan 40, whether the airflow is sourced from the fresh air intake 34 or recirculation air intake 36. Still yet, an advantage of the teachings of the present invention is that a filter change door 53 may be located in the air intake case 42 to permit quick and easy changing of the filter 52 within the air intake case 42. By using the filter change door 53, no fasteners or screws have to be removed from the blower assembly 14 to install or remove the filter 52.

Stated in slightly different terms and with reference to FIGS. 1-11, an apparatus for a heating, ventilating and air conditioning (HVAC) system 12 may employ a blower case 38 that houses a fan 40 and an electric motor 90 to drive the fan 40, an air intake case 42 defining a fresh air inlet 34 and a recirculation air inlet 36. An air filter 52 may be located in the air intake case 42 or in a separate case below the intakes 34, 36. An intermediate grill panel 98 may define a grill 54, 78, 82, 86, such that the intermediate grill panel 98 and the grill are an integrally molded single piece. Such a single piece reduces noise, vibration and harshness, and reduces manufacturing costs by reducing overall HVAC system part count. The grill may contact the filter 52 and physically support a weight of the filter 52. The grill may be located directly over the fan 40 to protect the fan from debris. A filter change door 53 may be located next to the filter 52 to provide access to the filter 52. Fresh air may enter and pass through the HVAC system in accordance to an airflow path 92 that may be in the order of: the fresh air intake 34 or recirculation air intake 36, the filter 52, the grill 54, the fan 40, and the blower case 38.

The grill 54 may further employ a quantity of polygonal apertures molded through the grill and disposed in the airflow path. The filter 52 may be positioned to absorb some or all noise waves deflected upwardly from the grill 54 that are created by the airflow passing through the grill 54. Each of the plurality of polygonal apertures is a six-sided polygon and has a width across opposing flat faces of between 4 millimeters and 5 millimeters.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Moreover, in the embodiments described, and with reference to FIG. 11 as an example, when the relative location of the blower case 38, intermediate grill panel 98, air intake 42, filter 52, grill 54, and other parts depicted in FIGS. 1-11, are being described, the blower case 38 is described as below or under the intermediate grill panel 98, which is under or below the air intake case 42. The grill 54 is located under or below the filter 54, which is supported or contacted from below by the grill 54. Such use of the term below or under is used with the ground, upon which the vehicle 10 may reside, as a reference. Thus, as an example, because the blower case 38 is closer to the ground than the intermediate grill panel 98 the blower case 38 is closer to the ground. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An apparatus for a heating, ventilating and air conditioning (HVAC) system comprising:
a blower case housing a fan;
an air intake case housing a filter;
a grill contacting the filter;
a fresh air intake; and
a recirculation air intake, the grill located directly over the fan to protect the fan from debris.

2. The apparatus of claim 1, wherein the grill is located under the filter.

3. The apparatus of claim 1, wherein the grill supports the filter.

4. The apparatus of claim 1, further comprising:
a fresh air inlet, wherein fresh air entering the HVAC system has an airflow path through the HVAC system in accordance with a structural order of: the fresh air intake, the filter, the grill, the fan, and the blower case.

5. The apparatus of claim 1, further comprising:
an intermediate grill panel, the grill and intermediate grill panel being a single integrally molded part, the intermediate grill panel located between and attached to the blower case and the air intake case.

6. The apparatus of claim 1, wherein the grill further comprises:
a plurality of polygonal apertures molded through the grill and disposed in the airflow path, the filter positioned to absorb some of all noise waves deflected upwardly and created by the airflow passing through the grill.

7. The apparatus of claim 6, wherein each of the plurality of polygonal apertures has a width of between 4 millimeters and 5 millimeters.

8. An apparatus for a heating, ventilating and air conditioning (HVAC) system comprising:
a blower case housing a fan and an electric motor to drive the fan;
an air intake case defining a fresh air inlet and a recirculation air inlet;
a filter located; and
an intermediate grill panel that defines a grill, the grill contacting the filter.

9. The apparatus of claim 8, wherein the grill physically supports a weight of the filter.

10. The apparatus of claim 9, wherein the grill is located directly over the fan to protect the fan from debris.

11. The apparatus of claim 10, wherein the intermediate grill panel and the grill are an integrally molded single piece.

12. The apparatus of claim 11, further comprising:
a filter change door located next to the filter to provide access to the filter.

13. The apparatus of claim 12, wherein fresh air entering the HVAC system has an airflow path through the HVAC system in accordance with a structural order of: the fresh air intake, the filter, the grill, the fan, and the blower case.

14. The apparatus of claim 13, wherein the grill further comprises:
a plurality of polygonal apertures molded through the grill and disposed in the airflow path, the filter positioned to absorb some of all noise waves deflected upwardly and created by the airflow passing through the grill.

15. The apparatus of claim 14, wherein each of the plurality of polygonal apertures is a six-sided polygon and has a width of between 4 millimeters and 5 millimeters.

16. An apparatus for a heating, ventilating and air conditioning (HVAC) system comprising:
a blower case housing a fan and an electric motor to drive the fan;
an air intake case defining a fresh air inlet and a recirculation air inlet;
an air filter located downstream of the fresh air inlet and the recirculation air inlet;
an intermediate grill panel that defines a grill, the grill further defining a flat surface that contacts the filter; and
a plurality of polygonal apertures molded through the flat surface of the grill and disposed in the airflow path.

17. The apparatus of claim 16, wherein the grill physically supports a weight of the filter.

18. The apparatus of claim 17, wherein the grill is located directly over the fan to protect the fan from debris.

19. The apparatus of claim 18, wherein the intermediate grill panel and the grill are an integrally molded single piece.

20. The apparatus of claim 19, further comprising:
a filter change door located next to the filter to provide access to the filter; and
a plurality of polygonal apertures molded through the grill and disposed in the airflow path, wherein each of the plurality of polygonal apertures is a six-sided polygon and has a width across opposing flat faces of between 4 millimeters and millimeters.
